(19) United States
(12) Patent Application Publication
(10) Pub. No.: US 2025/0306169 A1
(43) Pub. Date: Oct. 2, 2025

(54) TEST DEVICE FOR TESTING A DISTANCE SENSOR THAT OPERATES USING ELECTROMAGNETIC WAVES, AND FREQUENCY DIVIDER ASSEMBLY FOR SUCH A TEST DEVICE

(71) Applicant: dSPACE GmbH, Paderborn (DE)

(72) Inventors: Sebastian GRAF, Paderborn (DE); Jan BAUMHOEFER, Bad Lippspringe (DE)

(73) Assignee: dSPACE GmbH, Paderborn (DE)

(21) Appl. No.: 19/236,147

(22) Filed: Jun. 12, 2025

Related U.S. Application Data
(63) Continuation of application No. PCT/EP2023/084143, filed on Dec. 4, 2023.

(30) Foreign Application Priority Data
Dec. 13, 2022 (DE) 10 2022 133 124.5

(51) Int. Cl. G01S 7/40; G01S 13/08

(52) U.S. Cl. CPC G01S 7/406; G01S 7/4021; G01S 13/08

(57) ABSTRACT

A test device for testing a distance sensor that operates using electromagnetic waves, said test device comprising: a receiving element for receiving an electromagnetic free-space wave as a received signal with a reception frequency and a signal bandwidth. An emission element emits an electromagnetic output signal. During a simulation operation, the received signal or a received signal derived from the received signal is converted into a sampled signal by an analog-to-digital converter. The sampled signal is time-delayed using a signal processing unit to form a time-delayed sampled signal. The time-delayed sampled signal is converted into a simulated reflection signal by a digital-to-analog converter. The simulated reflection signal or a simulated reflection signal derived from the simulated reflection signal is emitted as an output signal by the emission element.

This nonprovisional application is a continuation of International Application No. PCT/EP2023/084143, which was filed on Dec. 4, 2023, and which claims priority to German Patent Application No. 10 2022 133 124.5, which was filed in Germany on Dec. 13, 2022, and which are both herein incorporated by reference.

### BACKGROUND OF THE INVENTION

### Field of the Invention

The invention relates to a test device for testing a distance sensor that operates using electromagnetic waves, said test device comprising a receiving element for receiving an electromagnetic free-space wave as a received signal with a reception frequency and a signal bandwidth; an emission element for emitting an electromagnetic output signal, wherein, during a simulation operation, the received signal, or a received signal derived from the received signal is converted into a sampled signal by means of an analog-to-digital converter, the sampled signal is time-delayed using a signal processing unit to form a time-delayed sampled signal, and the time-delayed sampled signal is converted into a simulated reflection signal by means of a digital-to-analog converter, wherein the simulated reflection signal or a simulated reflection signal derived from the simulated reflection signal is emitted as an output signal by means of the emission element. In addition, the invention also relates to a frequency divider assembly for the aforementioned test device.

### Description of the Background Art

Test devices for testing distance sensors are known from various areas of technology, for example from the field of ECU development and ECU testing, especially in the automotive sector; reference is made, for example, to WO 2020/165191 A1, which corresponds to US 2022/0099797, which is incorporated herein by reference.

Another field of application is end-of-line test benches, i.e., devices that are used at the end of a production line for product testing, in this case the inspection of distance sensors (EP 4109125 A1, which corresponds to US 2022/404464, which is incorporated herein by reference).

This is about testing distance sensors that operate with electromagnetic waves: radar sensors are predominantly used in the automotive sector. In principle, however, distance sensors can also be tested that operate with electromagnetic waves in a different frequency range, for example in the visible light range, or that operate with electromagnetic sources of radiation that emit electromagnetic waves with a long coherence length, such as in laser applications.

With test devices of this type, it is possible to simulate a reflection object at practically any distance from the distance sensor to be tested. Distance sensors of the type considered here basically operate in such a way that electromagnetic waves emitted by them are reflected by a reflection object in the emission range of the distance sensor; the distance sensor receives the reflected electromagnetic waves and determines the distance from the object from the propagation time of the electromagnetic waves. The signal propagation time can be determined directly (time-of-flight measurement), but it is often done indirectly via sent signal evaluations. While in the first case very short sensor signals are often used, i.e., pulses, in the latter case time-extended transmission signals are usually used, and the desired distance information is obtained from the frequency of the mixed signal from the emitted signal and the received reflection signal. Examples of time-extended transmission signals are frequency-modulated continuous wave signals.

The test device is positioned in its emission area to test the distance sensor; the test device receives the free-space waves emitted by the distance sensor and delays this received signal with its signal processing unit according to a preset time delay and then radiates the time-delayed signal via its emission element back towards the distance sensor to be tested, wherein the impression of a reflection object removed according to the set time delay is created at the distance sensor.

The adjustability of a time delay is a minimum requirement for the test device, as it can be used to simulate the basic property of the distance of the reflection object. Advanced test devices can also simulate radial motion components relative to the distance sensor. Due to the Doppler effect, the reflection signals are frequency-shifted in this case relative to the frequency of the transmission signal emitted by the distance sensor. Modern test devices are able to make corresponding frequency shifts of the simulated reflection signal relative to the frequency of the received signal in order to map preset radial motion components in the simulated reflection signal. With even more advanced techniques, complex Doppler signatures with multiple motion components can also be simulated.

On the input side, reference is made to the received signal and the received signal derived from the received signal, and on the output side, reference is made to the simulated reflection signal and the simulated reflection signal derived from the simulated reflection signal. The reason for this is simply that the original received signal may still undergo upstream signal processing on its way to digital signal processing by the signal processing unit, so that a strict distinction must be made between the received signal itself and the possibly intermediate received signal, which is then no longer the original received signal, but the received signal derived from the received signal. This is exactly the situation in the signal path downstream of the digital signal processing. Here, too, it is possible that the simulated reflection signal also undergoes intermediate signal processing on its way to the emission element, so that in strict terms, it is not the simulated reflection signal that is emitted as the output signal, but the simulated reflection signal derived from the simulated reflection signal.

The hardware requirements for the test device and thus for the signal processing unit are extremely high. Distance sensors often operate in the 80 GHz range with a bandwidth of a few GHz. A concrete example of a common application today for a test device for testing a distance sensor is a reception frequency of 79 GHz (center frequency) with a bandwidth of 4 GHz, so that the received signal to be processed is in a range of 77 to 81 GHz. It is obvious that the acquisition of the received signal, the processing of the received signal (sampling by analog-to-digital conversion, time delay, frequency shift, application of complex Doppler signatures, digital-to-analog conversion) is extremely demanding, as the processing times are in the nano to microsecond range.

For the simulation of reflection objects with different reflection behavior, for example due to different sizes of the objects, different surface material properties or different spatial alignment of reflection surfaces, it is also important, at least for the testing of such distance sensors that also evaluate the amplitude of the reflection signal, that the simulated reflection signal has a signal amplitude that varies from its size to that of the simulating reflection object. In short, the simulated reflection signal should have an amplitude that corresponds to the radar cross-section of the object at a certain distance, but this also means that the received signal amplitude must be known.

### SUMMARY OF THE INVENTION

It is therefore an object of the present invention to design and further develop a test device in such a way that the required signal processing is simplified.

The object is achieved in an example of the test device according to the invention by dividing the received signal into a first partial received signal and a second partial received signal with a signal splitter, wherein at least the second partial received signal has the amplitude information of the received signal. When using known signal splitters, both partial received signals usually have the amplitude information of the received signal. If it is said that the second partial received signal has the amplitude information of the received signal, then the second partial received signal does not have to have the amplitude of the received signal, but the amplitude of the second partial received signal is in any case in a certain relationship to the amplitude of the received signal, so that the information about the amplitude of the received signal can be determined by evaluating the amplitude of the second partial received signal.

The first partial received signal can be converted into a frequency-divided received signal that no longer has the amplitude information of the received signal using a frequency divider. The reason that the frequency-divided received signal no longer has the amplitude information of the received signal (even if the first partial received signal still has the amplitude information) is due to the fact that frequency dividers usually operate digitally and usually turn a sinusoidal oscillation into a square-wave signal of corresponding frequency, the amplitude of which, however, only changes back and forth between a minimum value and a maximum value.

The use of the frequency divider produces two effects. On the one hand, the reception frequency is reduced by division according to the division factor of the frequency divider. On the other hand, the bandwidth of the received signal is also reduced by the division factor of the frequency divider. Both effects have the consequence that the subsequent signal processing (analog-to-digital conversion, digital signal processing by the signal processing unit and digital-to-analog conversion) is considerably simplified and also more cost-effective to implement, as slower components can be used.

Furthermore, the amplitude information of the received signal can be obtained from the second partial received signal using an amplitude detector. In the case of the second partial received signal, it is not the frequency of the received signal that is of interest, but only its amplitude, which usually changes much more slowly than the oscillations of the received signal. Basically, an envelope detection is carried out.

A modulator can now be used to generate a frequency-divided received signal with the amplitude information of the received signal by modulating the amplitude information obtained from the second partial received signal onto the frequency-divided received signal without amplitude information. The frequency-divided received signal with the modulated amplitude information is then the received signal derived from the received signal, which is then digitally processed.

By dividing the received signal into a first partial received signal and a second partial received signal and by processing the partial received signals differently in the separated signal paths, once with regard to frequency and once with regard to amplitude, very simple signal processing can be implemented without loss of amplitude information, which would be unavoidable if only one signal path with a frequency divider were used. This means that the simulated reflection signal can also be easily adapted to a given radar cross-section of an assumed reflection object at a given distance to be simulated, which is not possible without knowing the amplitude of the received signal.

In the case of the test device, it is also provided that the simulated reflection signal can be converted to the signal derived from the simulated reflection signal using a frequency multiplier, i.e., that the frequency of the input signal, which has been lowered by the frequency divider, is now raised again on the output side.

The signal splitter can be implemented as a resistive power divider. This electrotechnically passive solution is easy to implement and very reliable. In principle, it is also possible to use active signal splitters or signal splitters that are based on a different principle.

The frequency divider can be implemented using digital technology, especially on the basis of bistable flip-flops. This solution is also reliable and simple and is also available as an integrated circuit. In particular, frequency dividers with a division factor corresponding to the reciprocal of a power of two can be easily realized by connecting flip-flops in series.

The amplitude detector can be realized with a rectifier and a downstream low-pass, in particular with a diode as a rectifier. The solution is also characterized by the fact that it is electrotechnically passive, simple and reliable.

In an advantageous further development of the test device, the division factor of the frequency divider can be chosen such that the smallest frequency of the frequency-divided received signal is equal to or greater than the signal bandwidth of the received signal multiplied by half the division factor. If the division factor is 1/x and the bandwidth of the received signal is B, then the frequency-divided received signal has a bandwidth of B/x. If the lowest frequency of the frequency-divided received signal is fₘᵢₙ, then the specified dimensioning rule is formulated as fₘᵢₙ>B/(2x). This dimensioning takes into account that the square-wave signals generated by the frequency division have harmonics with an odd multiple of the fundamental frequency. In the aforementioned realization of the frequency divider, the first harmonic of the lowest frequency of the frequency-divided received signal is in a higher frequency range than the maximum frequency of the frequency-divided received signal and thus outside the frequency-divided bandwidth of the frequency-divided received signal.

A low-pass filter may filter the frequency-divided received signal with the amplitude information, so that the harmonic fundamental oscillation of the frequency-divided received signal is obtained as a derived received signal.

Through filtering, a harmonic signal can be generated from a square-wave signal or the harmonic of interest of the fundamental frequency is extracted from a signal with many energy components in harmonics. The low-pass filter can also be located directly behind the frequency divider, resulting in a harmonic signal without amplitude information, and this harmonic signal can then be provided with the amplitude information by modulation.

The cut-off frequency of the low-pass can be between twice and three times the lowest frequency of the frequency-divided received signal. This is especially useful if the division factor of the frequency divider is selected, as described above.

A delay element can be provided in the signal path between the signal splitter via the frequency divider to the modulator and/or between the signal splitter via the amplitude detector to the modulator, wherein the delay element has such a delay time that the frequency-divided received signal and the amplitude information are joined together at the appropriate time. This compensates for different signal propagation times in the signal paths starting from the signal splitter.

The multiplication factor of the frequency multiplier can correspond to the reciprocal of the division factor of the frequency divider, wherein the simulated reflection signal is raised again to the reception frequency and the signal bandwidth of the simulated reflection signal is also stretched to the signal bandwidth of the received signal.

The frequency multiplier can be realized using a semiconductor component with nonlinear transmission behavior, which automatically generates harmonics. A diode or a transistor can be used as simple components. The frequency multiplier is then preferably followed by a bandpass in order to filter or allow the harmonics to pass through in the desired frequency range.

The received signal can be shifted to lower frequencies with a receiving converter and the signal derived from the simulated reflection signal (i.e., after the frequency multiplier) is shifted to higher frequencies with an output converter, wherein the frequency shifts, input, and output-side, are the same, in particular in terms of magnitude. The use of the receiving converter and the output converter do not affect the signal bandwidth, but they do lower or raise the frequency of the signal band. The frequency-shifted received signal would then be the input signal of the signal splitter, previously referred to as the received signal.

The object described above can also be achieved with a frequency divider array for a test device according to the invention. The frequency divider array is characterized in that a received signal with a signal splitter is divided into a first partial received signal and a second partial received signal, wherein at least the second partial received signal has the amplitude information of the received signal, that the first partial received signal is converted with a frequency divider into a frequency-divided received signal that no longer has the amplitude information of the received signal, that from the second partial received signal, the amplitude information of the received signal is obtained using an amplitude detector, that a frequency-divided received signal with the amplitude information of the received signal is generated using a modulator by modulating the amplitude information obtained from the second partial received signal onto the frequency-divided received signal without amplitude information and thus generating a derived received signal from the received signal. The components of the frequency divider array are designed as described above in connection with the test device.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a schematic test device for testing a distance sensor that operates using electromagnetic waves, as known from the prior art,

FIG. 2 shows a schematic amplitude spectra of the received signal and the received signal derived from the received signal, also as known from the prior art,

FIG. 3 shows a frequency divider array as it is realized in the reception path of the test device according to the invention,

FIG. 4 shows a schematic frequency multiplier in the output path of the test device according to an example of the invention,

FIG. 5 shows a schematic of an example of a frequency divider array of the test device,

FIG. 6 shows a schematic of an example of a frequency divider array in the test device,

FIG. 7 shows schematic of a test device with input and output frequency converter, and

FIG. 8 shows schematic amplitude spectra of different signals when using the frequency divider array in the test device.

### DETAILED DESCRIPTION

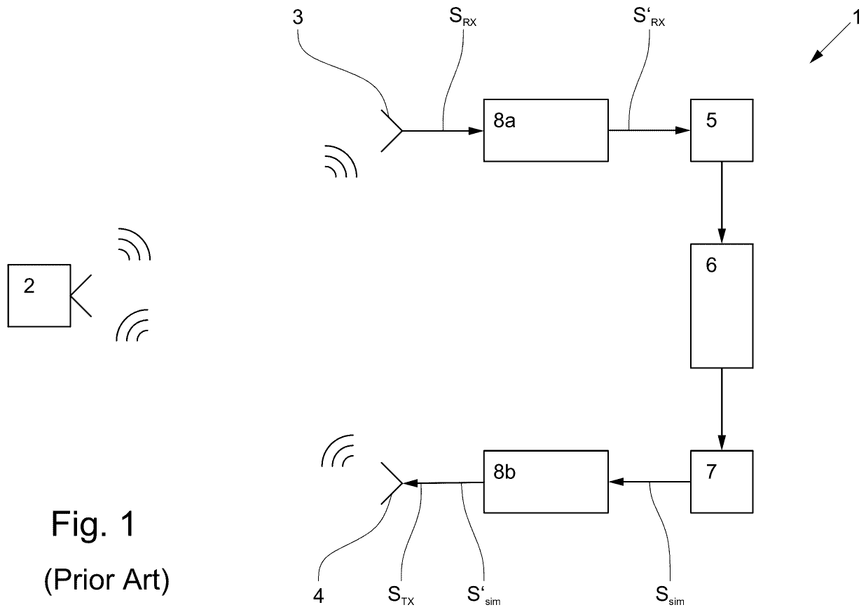

FIG. 1 shows a test device 1 known from the state of the art for testing a distance sensor 2 that operates using electromagnetic waves. The distance sensor 2, for example, is a radar distance sensor as used in the automotive sector. The distance sensor 2 emits a free-space wave that is reflected off a reflection object and receives the reflection signal. From the time delay, a frequency shift and, if applicable, the signal intensity of the reflection signal, the distance sensor can infer the distance from the reflection object, radial velocity components of the reflection object and, if applicable, the size, reflection properties, etc. of the reflection object; this depends on the design of the distance sensor 2. The test device 1 simulates an actual reflection object to the distance sensor 2 to be tested.

The test device 1 has a receiving element 3 for receiving the electric free-space wave emitted by a distance sensor 2 as a received signal S_{RX}. The S_{RX} received signal has a reception frequency f_{RX} and a signal bandwidth B. Furthermore, the test device 1 has an emission element 4 for the emission of an electromagnetic output signal S_{TX}.

In a simulation operation, the received signal S_{RX} or a received signal S′_{RX} derived from the received signal S_{RX} is converted into a sampled signal by means of an analog-to-digital converter 5, the sampled signal is converted into a time-delayed sampled signal with a signal processing unit 6, and the time-delayed sampled signal is converted into a simulated reflection signal Sₛᵢₘ by means of a digital-to-analog converter 7. The simulated reflection signal Sₛᵢₘ or a simulated reflection signal S′ₛᵢₘ derived from the simulated reflection signal Sₛᵢₘ is then emitted as an output signal S_{TX} via the emission element 4.

With the signal processing unit 6, the necessary measures are implemented to provide the simulated reflection signal with all essential signal properties, i.e., a desired signal delay, a desired frequency shift (or even several, differently frequency-shifted signal components) and, if necessary, also the desired amplitude of the simulated reflection signal Sₛᵢₘ.

In addition, as indicated in FIG. 1, there may be signal processing 8a upstream on the input side and also signal processing 8b downstream on the output side to the signal processing of the signal processing unit 6. For example, it is known to use an input mixer to downmix the received signal S_{RX} to a lower frequency range while preserving the bandwidth of the signal.

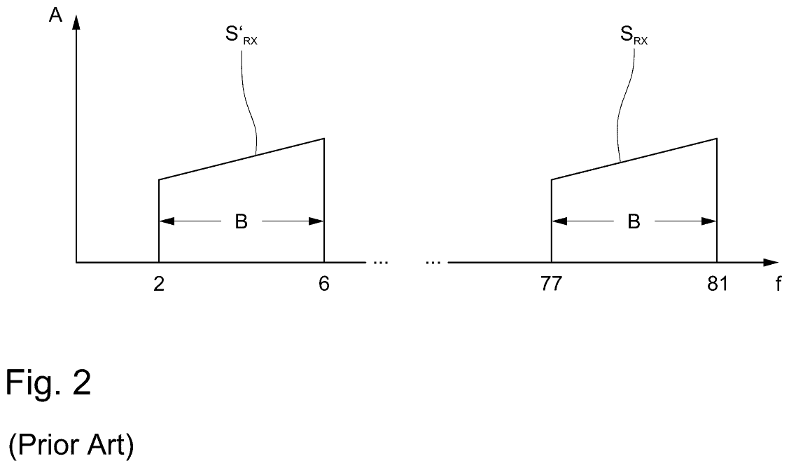

This results in the received signal S′_{RX} derived from the received signal S_{RX}. This situation is shown in FIG. 2 by an amplitude spectrum. The received signal S_{RX} has a bandwidth B of 4 GHz with a reception frequency f_{RX} of 79 GHz. The signal bandwidth B therefore extends from 77 GHz to 81 GHz. By using a mixer, which is part of the signal processing 8a upstream on the input side, the received signal S_{RS} is downmixed to an intermediate frequency of 4 GHz using a frequency of 75 GHz of a local oscillator, whereas the signal bandwidth B is retained. In this example, the received signal S′_{RX} derived from the received signal S_{RX} is created.

It is not explicitly shown that the signal processing 8b downstream on the output side uses a corresponding mixer with which the low-frequency simulated reflection signal Sₛᵢₘ is mixed up again into the range of the reception frequency f_{RX} and then emitted as a derived simulated reflection signal S′ₛᵢₘ. Since the bandwidth B of the received signal S_{RX} remains unchanged, the requirements dependent on the signal bandwidth B with regard to the sampling of the signal remain the same and remain high.

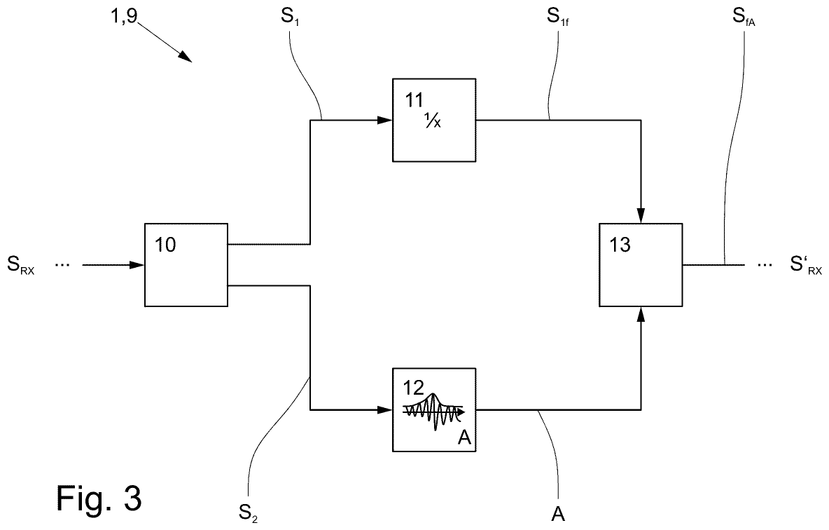

FIGS. 3 to 8 describe various aspects of a test device 1 according to the invention for testing the distance sensor 2 that operates using electromagnetic waves as well as a frequency divider array 9 according to the invention, which is part of the test device 1.

In FIG. 3, a frequency divider array 9 is first shown, which is part of the signal processing upstream on the input side. It can be seen that the received signal S_{RX} is divided into a first partial received signal S₁ and a second partial received signal S₂ with a signal splitter 10, wherein at least the second partial received signal S₂ has the amplitude information A of the received signal S_{RX}. In the present case, the signal splitter 10 is a resistive power divider, so that the first partial received signal S₁ also basically has the amplitude information A of the received signal S_{RX}. The first partial received signal S₁ is converted with a frequency divider 11 into a frequency-divided received signal S_{1f} that no longer has the amplitude information A of the received signal S_{RX}. The frequency-divided received signal S_{1f} does not have the amplitude information A because the frequency divider 11 outputs a digital output signal that still has the frequency information but no longer contains the amplitude information of the frequency-divided input signal.

From the second partial received signal S₂, the amplitude information A of the received signal S_{RX} is obtained with an amplitude detector 12. In the present case, the envelope of the second partial received signal S₂ is detected.

Finally, a frequency-divided received signal S_{fA} with the amplitude information A of the received signal S_{RX} is generated with a modulator 13 by modulating the amplitude information A obtained from the second partial received signal S₂ onto the frequency-divided received signal without amplitude information S_{1f}. In this way, the received signal S′_{RX} derived from the received signal S_{RX} is generated. With the described frequency divider array 9, it is possible to compensate for the loss of the amplitude information A when using a frequency divider 11 in a clever way by recovering the amplitude information A in a separate signal path and modulating the frequency-divided received signal S_{1f} that no longer has the amplitude information A again.

The use of the frequency divider 11 has the advantage that the reception frequency f_{RX}, i.e., the center frequency of the received signal S_{RX}, is not only reduced by the division factor 1/x of the frequency divider 11, but also that the signal bandwidth B of the received signal S_{RX} is reduced by the same factor, so that the requirements for further signal processing are correspondingly lower.

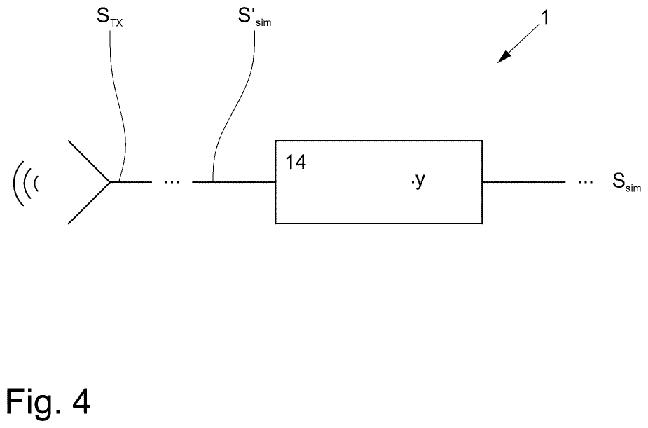

FIG. 4 shows a further aspect of the test device 1, namely that the simulated reflection signal Sₛᵢₘ is converted to the signal S′ₛᵢₘ derived from the simulated reflection signal Sₛᵢₘ with a frequency multiplier 14. In the present case, the multiplication factor y of the frequency multiplier 14 is equal to the reciprocal of the division factor 1/x of the frequency divider 11.

This accurately cancels out the effects of the frequency divider 11 (lowering the center frequency and reducing bandwidth).

In the examples shown, the frequency divider 11 is implemented using digital technology, namely on the basis of fast bistable flip-flops.

In the examples shown, the amplitude detector 12 is realized with a rectifier and a downstream low-pass, namely with a diode as a rectifier.

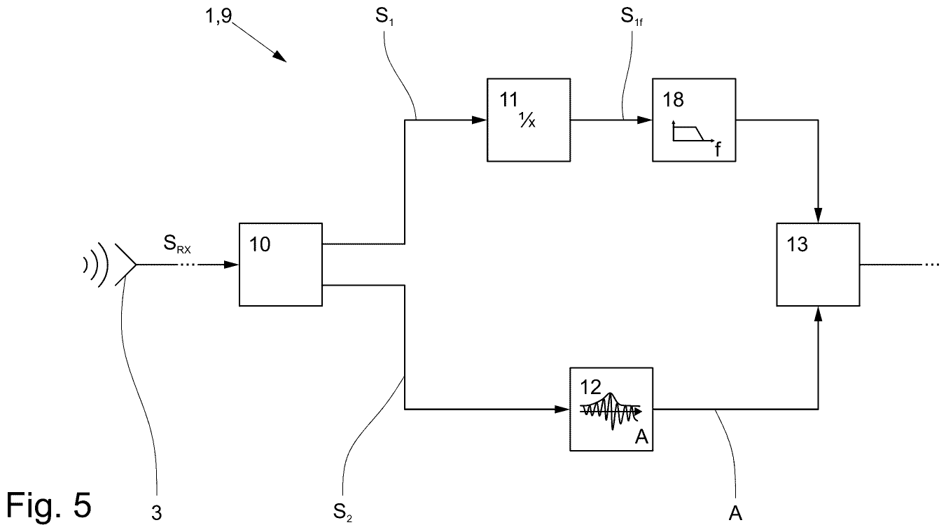

FIG. 5 shows that the frequency divider 11 is followed by a low-pass filter 18, which only allows the harmonic fundamental oscillation of the frequency-divided received signal to pass through without amplitude information S_{1f}. In this way, the square-wave signal resulting from the frequency division can be easily converted into a clean sinusoidal oscillation.

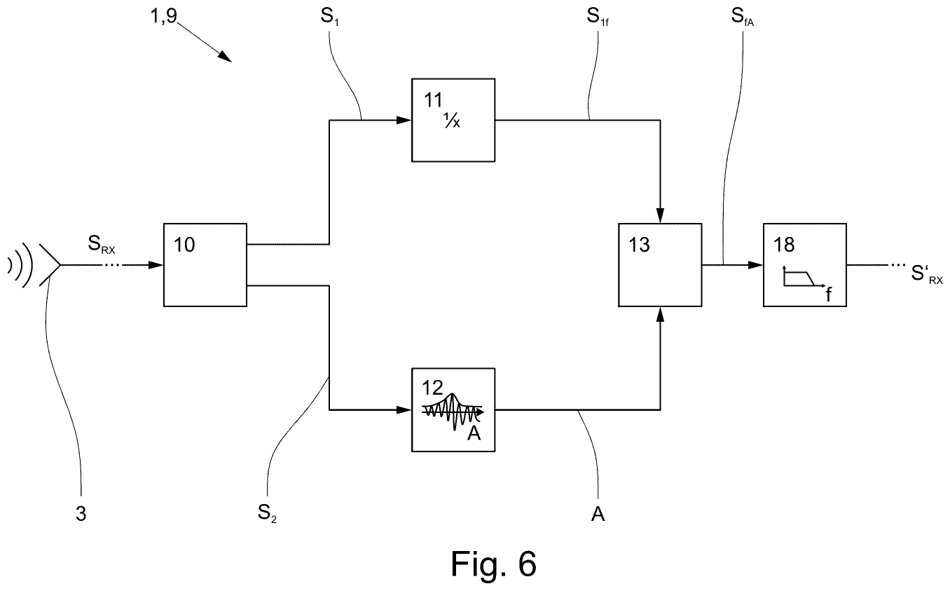

FIG. 6 shows an alternative implementation of the test device 1 or the frequency divider array 9, in which the low-pass filter 18 filters the frequency-divided received signal with the amplitude information S_{fA} in such a way that only the harmonic fundamental oscillation of the frequency-divided received signal S_{fA} results as a derived received signal S′_{RX}.

In both of the above-mentioned examples according to FIGS. 5 and 6, the low-pass 18 is designed in such a way that its cut-off frequency is between twice and three times the lowest frequency of the frequency-divided received signal S_{1f}, S_{fA}.

The examples also have in common that the multiplication factor y of the frequency multiplier 14 corresponds to the reciprocal of the division factor x of the frequency divider 11, which cancels out the frequency shifts as well as the bandwidth reduction and bandwidth expansion on the input and output sides.

The test devices 1 in the examples have in common that the frequency multiplier 14 is realized using a diode for the generation of harmonics. To filter a harmonic, in this case the one with four times the fundamental frequency, a bandpass is downstream.

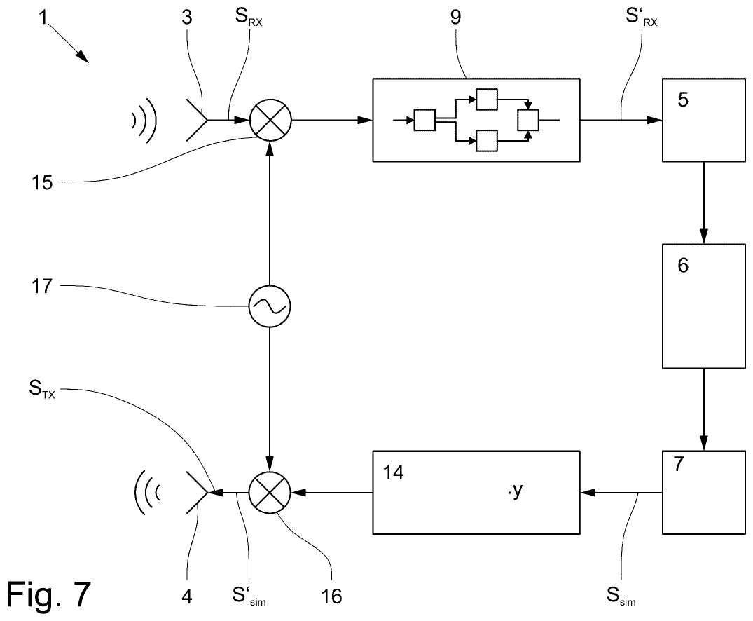

FIG. 7 shows a test device 1 in which the received signal S_{RX} is shifted towards low frequencies with a receiver converter 15 and in which the output signal of the frequency multiplier 14 is shifted to higher frequencies with an output converter 16, wherein the frequency shifts here are equal in magnitude. The receiving converter 15 and the output converter 16 are mixers to which a local oscillator 17 applies a harmonic signal with a corresponding frequency for increasing and decreasing the respective frequency of the input signal. The received signal S_{RX} is already frequency-shifted here before it is further processed by the frequency divider array 9 in the manner described. In order not to have to use other identifiers, it is referred to as the received signal S_{RX}.

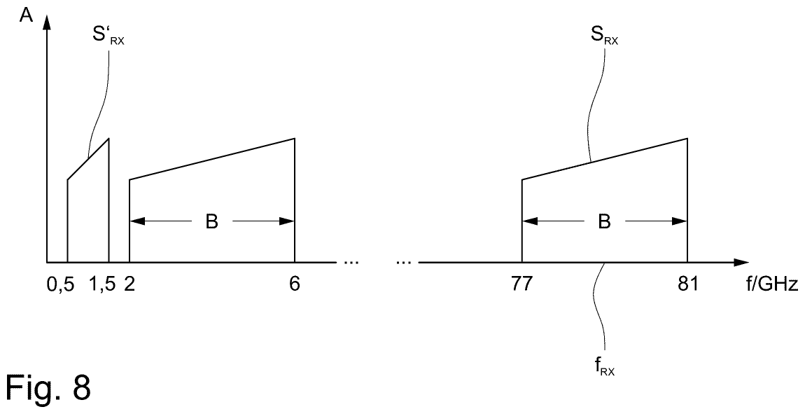

FIG. 8 shows the amplitude spectrum of various signals that result from the use of the frequency divider array 9 in the test device 1 according to FIG. 7. Here, too, the received signal S_{RX} has a bandwidth B of 4 GHz with a center frequency of 79 GHz. The receiver converter 15 is fed by the local oscillator 17 with a mixing frequency of 75 GHz, so that the reduced received signal S_{RX} with the unchanged bandwidth B of 4 GHz results in the range of 2 to 6 GHz. This signal is used to feed the frequency divider array 9, wherein the frequency divider 11 used has a division factor 1/x=¼. The bandwidth B is therefore reduced by a factor of 4, i.e., to 1 GHz. The limiting frequencies are also reduced by a factor of 4 and are now 0.5 GHz and 1.5 GHz. When choosing the division factor 1/x, care was taken to ensure that the lowest frequency of the frequency-divided received signal S_{1f} is equal to or greater than the signal bandwidth B of the received signal multiplied by half the division factor 1/x, i.e., multiplied by 1/(2x).

The bandwidth-reduced (B/x) received signal S′_{RX}, derived from the received signal S_{RX}, is easier to handle by the following digital signal processing than a signal with the original, larger bandwidth B. Therefore, it is possible to use less fast power electronic components, which enables the use of less sophisticated and thus often cheaper hardware components.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A test device to test a distance sensor that operates using electromagnetic waves, the test device comprising:
a receiver to receive an electromagnetic free-space wave as a received signal with a reception frequency and a signal bandwidth;
an emitter to emit an electromagnetic output signal, wherein, during a simulation operation, the received signal or a received signal derived from the received signal is converted into a sampled signal via an analog-to-digital converter, the sampled signal being time-delayed using a signal processing unit;
a digital-to-analog converter to convert the time-delayed sampled signal into a simulated reflection signal, the simulated reflection signal or a reflection signal being derived from the simulated reflection signal is emitted as an output signal by the emitter;
a signal splitter to divide the received signal into a first partial received signal and a second partial received signal, at least the second partial received signal containing amplitude information of the received signal;
a frequency divider to convert the first partial received signal into a frequency-divided received signal that no longer contains the amplitude information of the received signal;
an amplitude detector to obtain amplitude information of the received signal from the second partial received signal;
a modulator to generate a frequency-divided received signal with the amplitude information of the received signal by modulating the amplitude information obtained from the second partial received signal onto the frequency-divided received signal without amplitude information and thus generating the received signal derived from the received signal; and
a frequency multiplier to convert the simulated reflection signal to the signal derived from the simulated reflection signal.

2. The test device according to claim 1, wherein the signal splitter is a resistive power divider.

3. The test device according to claim 1, wherein the frequency divider is based on digital technology or bistable flip-flops.

4. The test device according to claim 1, wherein the amplitude detector is a rectifier and a downstream low-pass, or a diode as rectifier.

5. The test device according to claim 1, wherein a division factor of the frequency divider is chosen such that the lowest frequency of the frequency-divided received signal is equal to or greater than the signal bandwidth multiplied by half the division factor.

6. The test device according to claim 1, wherein a low-pass filter filters the frequency-divided received signal with the amplitude information so that the harmonic fundamental oscillation of the frequency-divided received signal as a derived received signal.

7. The test device according to claim 6, wherein the cut-off frequency of the low-pass is between two and three times a lowest frequency of the frequency-divided received signal.

8. The test device according to claim 1, wherein a multiplication factor of the frequency multiplier corresponds to a reciprocal of the division factor of the frequency divider.

9. The test device according to claim 1, wherein the frequency multiplier is a semiconductor component with nonlinear transmission behavior for the generation of harmonics, or is a diode or is a transistor.

10. The test device according to claim 1, wherein the received signal is shifted to lower frequencies with a receiving converter, and wherein the output signal of the frequency multiplier is shifted to higher frequencies with an output converter where frequency shifts are equal in magnitude.

11. A frequency divider array for the test device according to claim 1, wherein a received signal is divided into a first partial received signal and a second partial received signal using a signal splitter, wherein at least the second partial received signal contains the amplitude information of the received signal, wherein the first partial received signal is converted by a frequency divider into a frequency-divided received signal no longer containing the amplitude information of the received signal, wherein the amplitude information is obtained from the second partial received signal using an amplitude detector of the received signal, wherein a modulator is used to generate a frequency-divided received signal with the amplitude information of the received signal by modulating the amplitude information obtained from the second partial received signal onto the frequency-divided received signal without amplitude information and thus generating a derived received signal from the received signal.
